(19) United States
(12) Patent Application Publication
(10) Pub. No.: US 2016/0133397 A1
(43) Pub. Date: May 12, 2016

(54) METHOD FOR PRODUCING A MODULE FOR THE STORAGE OF ELECTRICAL ENERGY, ASSOCIATED PRODUCTION TOOL AND MODULE FOR THE STORAGE OF ELECTRICAL ENERGY, OBTAINED BY IMPLEMENTING THE METHOD

(71) Applicant: BLUE SOLUTIONS, Ergue Gaberic (FR)

(72) Inventors: Jean-Marc Gouzerh, Quimper (FR); Philippe Sagel, Edern (FR); Laurent Le Gall, Ergue Gaberic (FR); Anne-Claire Juventin-Mathes, Quimper (FR)

(21) Appl. No.: 14/898,721

(22) PCT Filed: Jun. 24, 2014
(86) PCT No.: PCT/EP2014/063300

§ 371 Date: Dec. 15, 2015

(30) Foreign Application Priority Data
Jun. 27, 2013 (FR) 1356217

(51) Int. Cl. H01G 11/84; H01M 10/052; H01M 10/058; H01M 2/20; H01G 11/10; H01G 11/78

(52) U.S. Cl. CPC H01G 11/84; H01G 11/10; H01G 11/78; H01M 10/058; H01M 2/204; H01M 2/206; H01M 10/052

(57) ABSTRACT

The invention relates to a module including assemblies for storing electrical energy, and to a tool and a method for producing such a module, said method comprising the positioning of at least one electroconductive strip on the assemblies, the position of the at least one strip being pre-determined in relation to at least one reference plane. The invention also relates to a tool allowing the production of said module. Said tool comprises elements allowing the elements (capacitors) to be held against each other while the connection strips are welded to the elements.

### TECHNICAL FIELD

The present invention relates to the general technical field of the manufacturing of a module for storing electrical energy including a plurality of electric energy storage assemblies.

Within the scope of the present invention, by “an electrical energy storage assembly” is meant either a capacitor (i.e. a passive system comprising two electrodes and an insulator), or a supercapacitor (i.e. a system comprising at least two electrodes, an electrolyte and at least one separator), or a battery of the lithium battery type (i.e. a system comprising at least one anode, at least one cathode and a liquid or solid electrolyte between the anode and the cathode).

### GENERAL PRESENTATION OF THE PRIOR ART

In the state of the art, methods for manufacturing a module for storing electrical energy are known. These manufacturing methods differ depending on the type of desired module.

### Use of a Supporting Member

Modules are known, comprising a casing in which are positioned several electrical energy storage assemblies.

Each assembly is for example of the tubular supercapacitor type. It comprises a cover including a tubular body, a capacitive winding and a liquid electrolyte inside the cover. For each assembly, two lids are used for closing both ends of the cover. Each lid is electrically connected to the capacitive winding.

Inside the module, the assemblies are connected pair wise alternately at their upper and lower ends by using connecting straps. The connection of a lid with a connecting strap is made by force-fitting the strap on the connecting terminal of the lid, and/or by welding and/or by screwing.

The method for manufacturing such a module may comprise the setting into place of an electrically insulating supporting member as described in French patent application filed under the number FR 1 253 982. This supporting member gives the possibility of avoiding unintended electrical contacting of the assembly with each other.

The supporting member comprises apertures intended to receive each respective assembly. The dimensions of each aperture are greater than the space theoretically occupied by each assembly. This provides compensation for:
the assembly plays (clearances) induced by the assembling of the different parts making up the whole (faults in the centering of the lids relatively to the tubular body of the cover), and
the error margin on the dimensions of the different parts forming the assemblies (manufacturing tolerances).

However, the use of a supporting member increases the size of the module since it is necessary to provide spaces between the assemblies in order to take into account manufacturing tolerances. It is possible to select a more reduced size but the proportion of discarded assemblies will then substantially increase, which would considerably increase the manufacturing cost and would not form an economically viable model.

The manufacturing method may alternatively comprise the setting into place of electrically insulating ossicles between the lids of the adjacent assemblies in order to maintain them in position relatively to each other.

However, the design of the ossicles should take into account variations in the dimensions of the adjacent assemblies (with all in all a maximum of four) and is therefore difficult to apply considering the manufacturing tolerances of the assemblies.

### Use of a Dual Lid

Modules are also known in which the assemblies are connected pairwise by using a one-piece longitudinal part—so-called with a dual lid—forming both a lid and connecting strap. Such a longitudinal part is notably described in the document published under the number of FR 2 894 381.

The manufacturing method therefore comprises the setting into place of dual lids on which are positioned the assemblies.

The use of a dual lid for electrically connecting two adjacent assemblies gives the possibility of increasing the electric and thermal performances of the modules.

However, the use of dual lids increases the complexity of the method for manufacturing the modules.

An object of the present invention is to propose a method for manufacturing a module giving the possibility of obtaining an electrical energy storage module with minimum size by means of a relatively simple and inexpensive manufacturing method.

### PRESENTATION OF THE INVENTION

For this purpose, the invention proposes a method for manufacturing an electrical energy storage module including electrical energy storage assemblies, each assembly including an external cover and an electrical energy storage element positioned inside the cover, the method comprising the following steps:
setting into place at least one electrically insulating sleeve around the cover of at least one assembly so that a sleeve is interposed between each pair of adjacent assemblies, the at least one sleeve at least partly covering the cover of the at least one assembly,
placing one of the ends of each assembly on a support, so that the longitudinal axis of the assemblies extends substantially parallel with each other,
applying at least one force on the assemblies along a direction substantially perpendicular to the longitudinal axis of the assemblies, the at least one force tending to flatten the assemblies against each other,
the positioning of at least one electrically conducting strap on the assemblies so as to electrically connect said assemblies, the position of the at least one strap being predetermined relatively to at least one reference plane of the support containing a direction parallel to that of the longitudinal axis of the assemblies,
the connection, notably by welding, of the at least one strap on the assemblies.

Within the scope of the present invention, by “sleeve”, is meant an annular element, such as a ring, either continuous or not over 360°.

This sleeve may be elastic for facilitating its setting into place and its maintaining during the assembling phase. Alternatively, the sleeve may be made in a non-elastic material and comprise a slot—such as an oblique slot, a curvilinear slot, etc.—over the whole of its height. This slot imparts radial elasticity allowing it to be inserted and to be more easily maintained on the assembly. Alternatively, the sleeve may be made in a heat-retractable material.

By providing the assembly(ies) with an electrically insulating sleeve, it is possible to get rid of the difficulty relating to the use of ossicles intended to be positioned between different assemblies. Indeed, the setting into place of the electrically insulating sleeve exclusively depends on the assembly plays of a single assembly, while the setting into place of an ossicle depends on the assembly plays of several (notably four) adjacent assemblies.

Moreover, by flattening the assemblies provided with electrically insulating sleeves against each other, it is possible to avoid the generation of dead space between adjacent assemblies, and therefore allows limitation of the size of the module.

Finally, the reader will appreciate that the position of the strap depends on reference planes, independently of the positions actually occupied by the assemblies, the actual position of each assembly may vary from one module to the other because of the assembly plays related to the variability in the dimensioning of the different parts making up the module.

By defining the position of the strap(s) depending on the position of one or several reference planes of the support (and not on actual positions of the assemblies) it is possible to obtain a method for manufacturing a module in which the position of the straps relatively to a reference system outside the module is substantially constant between two identical modules, even if the actual positions of the assemblies vary between both of these identical modules.

This has an advantage with regard to the output terminals of the module intended to be connected to external members. Indeed, these output terminals are attached to straps of the module. By defining the position of the straps relatively to reference planes, the manufacturing method gives the possibility of obtaining a module in which the position of the output terminals (with respect to a reference system outside the module) is absolutely identical from one module to the other.

Preferred but non-limiting aspects of the method according to the invention are the following:
the position of the at least one strap is defined before the step for placing the assemblies so that said position is independent of the actual positions of the assemblies;
the reference plane(s) do not contain any of the longitudinal axes of the assemblies, the step for applying a force tending to flatten the assemblies against each other and against the reference plane(s) of the module;
the assemblies are flattened against at least two reference planes, the reference planes being perpendicular to each other, at least one of the reference planes preferably being a plane of symmetry of the assemblies;
at least two forces with distinct directions are applied in the plane normal to the longitudinal axes on the assemblies in order to flatten them against each other;
the method comprises, prior to the step for applying at least one force, a step consisting of predetermining the position of the at least one strap by taking into account a range of positions which may be occupied by the assemblies depending on the assembly plays of the module. However, by knowing the manufacturing tolerances of the assemblies, it is possible to determine once and for all the modules the shape and the positioning of the straps so that each of the straps is only in contact with both assemblies which it has to connect electrically;
during the placement step, each sleeve is positioned so as to cover one of the ends of a respective cover, the placement step being applied so that the sleeves of the adjacent assemblies are located on opposite longitudinal ends of the assemblies positioned side by side;
the sleeve consists in a heat-retractable material, the placement method comprising a substep consisting of heating the sleeve;
each cover includes a body comprising a side wall and at least one open end, the method comprising a step consisting of positioning a lid over each open end of the body so as to close the at least one open end, each lid including a covering wall consisting:
   of an internal face intended to be connected to the electrical energy storage element, and
   of a substantially planar external face, notably without any pin in its centre and of an edge at its periphery;
the step for positioning the at least one strap comprises the substeps consisting of:
   laying out the at least one strap on a supporting mask at a predetermined position relatively to said reference plane(s), and
   affixing the supporting mask of the positioning means of the support;
the connecting step comprises a substep consisting of displacing at least one assembly, notably each assembly, along a direction substantially parallel to the longitudinal axes of the assemblies, so that the assemblies are bearing against the at least one strap;
during the substep consisting of displacing at least one assembly along a direction substantially parallel to the longitudinal axes of the assemblies, the assemblies and the straps are moved so that the straps are bearing against a reference plane of the support, said to be perpendicular, essentially normal to the longitudinal axes of the assemblies placed on the support (i.e. horizontal);
the method further comprises a step for producing elementary pairs of assemblies before the placement step, said production step comprising the substeps consisting of:
   i) positioning two assemblies so that their longitudinal axes extend substantially parallel,
   ii) pushing both assemblies against each other,
   iii) installing and welding a connecting strap on both assemblies, the position of the connection strap on both assemblies being notably predetermined,
   iv) repeating steps i) to iii) in order to obtain a plurality of elementary pairs,
the step for placing the assemblies consisting of placing the end welded to the connecting strap of each elementary pair on the support so that the connection strap of each elementary pair is in contact with the support;
during the step for displacing the assemblies along the longitudinal axes, the strap connected to the pair of assemblies is deformed so that the strap located at the opposite longitudinal end is bearing upon the perpendicular reference plane, the strap preferably including to do this two rigid portions connected to the assemblies and a deformable portion extending between both rigid portions;
during the step for producing elementary pairs (before placing the pairs on the support), the substep consisting of installing and welding comprises the displacement of at least one assembly, notably each assembly, along a direction substantially parallel to the longitudinal axes of the assemblies, so that the assemblies are bearing against the connection strap, and optionally the strap is in contact with a reference plane perpendicular to the longitudinal axes.

The invention also relates to a manufacturing tool for applying a method for manufacturing an electrical energy storage module as aforementioned, including electrical energy storage assemblies, each assembly including an external cover and an electrical energy storage element positioned inside the cover, at least one electrically insulating sleeve being set into place around the external cover of at least one of the assemblies so that a sleeve is interposed between each pair of adjacent assemblies, the tool comprising:
at least one support for placing one of the ends of each assembly, so that the longitudinal axes of the assemblies extend substantially parallel with each other,
at least one force applicator for applying at least one force on the assemblies along a direction substantially perpendicular to the longitudinal axes of the assemblies, the at least one force tending to flatten the assemblies against each other.

Preferred but non-limiting aspects of the tool according to the invention are the following:
the tool comprises positioning means, secured to the support, of at least one electrically conducting strap, optionally by means of a supporting mask, on the assemblies so as to electrically connect to said assemblies, the position of the at least one strap being predetermined relatively to at least one, notably two reference planes of the support containing a direction parallel to the longitudinal axes of the assemblies, at least one of the planes being preferably delimited by wall(s) of the tool;
the support comprises at least two trays, each tray being intended for receiving a respective assembly, at least one tray, notably each tray, being translationally movable for moving at least one assembly, notably each assembly along a direction substantially parallel to the longitudinal axes of the assemblies, so that the assemblies are bearing against the at least one electrically conducting strap, and optionally the strap is in contact with a reference plane perpendicular to the longitudinal axes, i.e. horizontal;
at least one tray, notably each tray, is translationally movable along a direction perpendicular to the longitudinal axes of the assemblies in order to flatten at least one assembly, notably each assembly, against the other assemblies;
the support consists of two frames intended to each receive at least one assembly, said frames being translationally movable relatively to each other between:
   a separated position wherein both frames are distant from each other in order to allow passing of the wiring of the module between the latter, and
   a closer position wherein the frames are in contact with each other.

The invention also relates to an electrical energy storage module including electrical energy storage assemblies, each assembly including an external cover and an electrical energy storage element positioned inside the cover, the module further comprising:
at least one electrically insulating sleeve around the cover of at least one of the assemblies so that a sleeve is interposed between each pair of adjacent assemblies, the at least one sleeve covering at least partly the external cover of the assembly, the assemblies being flattened against each other so that each sleeve is in contact with at least one of the adjacent assemblies,
at least one electrically conducting strap on the assemblies so as to electrically connect said assemblies, the position of the at least one strap being predetermined relatively to at least one reference plane containing at least one direction parallel to the longitudinal axes of the assemblies, said strap being a part which extends longitudinally and which comprises a deformable portion between two rigid portions, each of the rigid portions being respectively connected to an assembly. Preferred but non-limiting aspects of the module according to the invention are the following:
the position of the at least one strap is independent of the actual position of the assemblies of the module. In other words, the reference planes are defined independently of the actual position of the assemblies in the module;
the module further comprises a casing into which are inserted the assemblies, the casing including at least one wall and a bottom, the at least one reference plane being defined relatively to said or the at least one of the walls of the casing, for example a wall on which are laid out the output terminals of the casing. Indeed it is possible to position the walls of the casing relatively to the reference plane(s) of the support so that their position does not vary relatively to these planes;
the deformable portion is a thinned portion (in width or in thickness) for which the thickness is less than the thickness of the rigid portions. The straps may be placed between the assemblies so that at least one of the straps is slightly bent in order to compensate for the height differences of the assemblies;
the cover of least one assembly, notably each assembly, comprises bellows giving the possibility of varying the height of the assembly.

The invention also relates to a batch of two modules according to the invention in which the position of the straps relatively to the respective casings of the modules is identical in both modules while the position of the assemblies relatively to said casings is different.

### PRESENTATION OF THE FIGURES

Other features, objects and advantages of the present invention will further emerge from the description which follows, which is purely illustrative and non-limiting and should be read with reference to the appended drawings wherein:

FIG. 1 illustrates a method for manufacturing an electrical energy storage module,

FIG. 2 is a perspective view of a first embodiment of a tool for manufacturing an electrical energy storage module,

FIGS. 3 and 4 are respectively schematic top and side views of a second embodiment of a tool for manufacturing an electrical energy storage module,

FIG. 5A is a perspective view of a tool according to an alternative of the second embodiment of the invention,

FIG. 5B illustrates a perspective view of a detail of the tool of FIG. 5A,

FIG. 5C is a partial perspective view of the tool of FIGS. 5A and 5C when the assemblies and the straps are placed in the latter,

FIG. 5D is a perspective view of the tool when the cover is folded back onto the support.

### DESCRIPTION OF THE INVENTION

Different embodiments of the invention will now be described with references to the figures. In these different figures, the equivalent elements bear the same numerical references. Moreover, in the continuation of the text, the terms of “vertical”, “horizontal”, “above” or “on”, and “below” or <<under>> will be used with reference to an orthonormal reference system for which one of the axes is substantially parallel to the longitudinal axes of the assemblies of the module. This axis substantially parallel to the longitudinal axes of the modules will be considered as the vertical axis in the described examples.

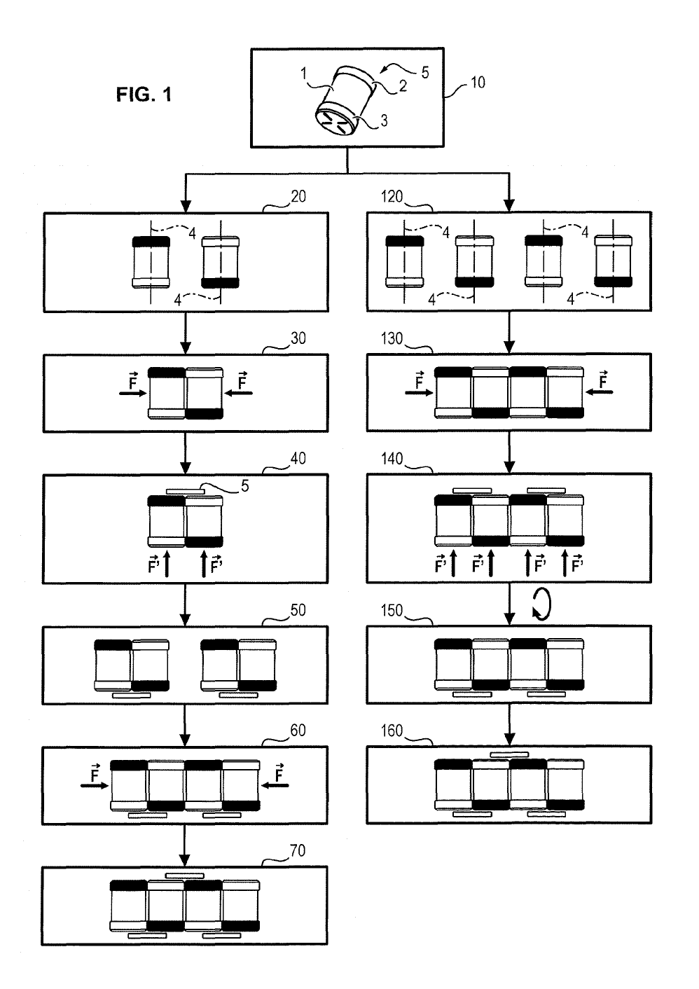

Exemplary methods and tools for manufacturing an electrical energy storage module are illustrated in FIGS. 1 to 5.

1. An Electrical Energy Storage Module

The module comprises a casing in which are housed assemblies for storing electrical energy 5. These assemblies 5 are capped with lids 2, and are connected with each other (in series or in parallel) by using electrically conducting straps 6.

1.2. Electrical Energy Storage Assembly

Each assembly 5 includes an external cover 1 containing an electrical energy storage element.

The element is for example a coil consisting of complexes and of a separator wound together in turns in order to form the coil. Within the scope of the present invention, by “complex” is meant a stack including at least two layers, notably two layers of electrodes intended to form the positive and negative electrodes of the complex.

The body 1 is of a cylindrical shape and comprises a side wall. It may also comprise a bottom at one of its ends and be open at its other end in order to allow the insertion of the storage element into the cover. In this case, the external face of the bottom is preferably substantially planar—in order to allow welding of a strap at any point of its surface.

Alternatively, the body 1 may be open at both of its ends.

In every case, each open end of the body is closed by a lid 2.

1.3. Lid

Each lid 2 comprises a covering wall for closing the open end of the body 1. This covering wall comprises two faces:
an internal face intended to be connected to the energy storage element, and
an external face intended to be bound, notably by welding to a strap.

Preferably, the external face of the lid is substantially planar. More specifically, this external face is preferably without any pin in its center and on the edge at its periphery. This gives the possibility of maximizing the surface area of the lid which may be welded to the strap. The latitude of welding of the strap on the lid is thereby increased, the position of the strap may vary quite considerably relatively to the position of the assembly on which it is welded, as this will be described in more detail subsequently. The invention may however be carried out with an assembly comprising a pin on its external face at least located at one of its ends.

Each lid may also comprise a skirt at the periphery of the covering wall, this skirt being intended to partly cover the side wall of the cover.

Advantageously, the cover, notably its body 1, may comprise bellows notably located at the side wall of the cover. This bellow, not shown in the figures, gives the possibility of varying the height of the assembly in order to compensate for the possible height variations of the different assemblies, notably related to the manufacturing tolerances of the different parts or further to the assembly plays resulting from their assembling.

1.4. Electrically Conducting Strap

As indicated earlier, the assemblies of the module are connected pair wise at their upper and lower ends by using straps.

Each strap is for example a substantially planar plate extending longitudinally and for example consisting of portions with different rigidities, even if this is not essential for managing to carry out the invention. Notably, each strap may comprise:
two rigid portions, each being intended to be put into contact with a respective lid of two adjacent storage assemblies,
a deformable portion between both rigid portions.

The presence of a deformable portion on the strap gives the possibility of facilitating its deformation by bending without breaking with view to its connection on the assembly, notably by guaranteeing that the strap bears upon the assemblies even if their heights are different. This gives the possibility of guaranteeing the quality of the connection. This is particularly advantageous in the case when the connection of the strap on the assembly is produced by welding, notably laser welding, since an intimate contact is required for efficiently producing a weld by means of this technology.

The difference in rigidity of the different portions forming the strap may be obtained by varying the thickness of the plate longitudinally. Notably, the deformable portion may be a thinned portion with a thickness of less than the thickness of the rigid portions. It may also be made by means of a fold or of a shift in the central portion of the strap. The strap may also consist of a plurality of superposed sheets bound together, notably by welding, at each of their ends or of a plurality of wires braided together in order to form the strap, which also gives good flexibility to the strap in the locations where it is not connected to the assemblies.

1.5. Electrically Insulating Sleeve

The module also comprises electrically insulating sleeves on the assemblies. The electrically insulating material forming the sleeve is for example an elastomer, notably ethylene-propylene-diene monomer (EPDM). The use of an EPDM sleeve gives the possibility of reducing the effect of external impacts on the assemblies by the damping properties of EPDM and of adapting the variations in dimensions due to the manufacturing tolerances of the assemblies.

Each sleeve surrounds a respective assembly, and covers all or part of the cover.

In certain embodiments, the module comprises one sleeve per assembly. In other embodiments, the module comprises a number of sleeves less than the number of assemblies, the sleeves being positioned so that a sleeve is interposed between each pair of adjacent assemblies, notably so that a sleeve is interposed between each pair of assemblies at each end of the assemblies.

Each sleeve may have an annular shape at rest, such as a ring either continuous or not over 360°. Alternatively, the sleeve may have a substantially planar shape at rest, such as a flexible ribbon, and be positioned and attached around the assembly.

With the presence of an insulating sleeve interposed between each pair of adjacent assemblies, it is possible to flatten the assemblies of the module against each other in order to limit the size of the module.

2. Manufacturing Method

With reference to FIG. 1, two embodiments of a method for manufacturing a module are illustrated.

In both of these embodiments, the method comprises a first step for setting into place sleeve(s) around assembly(ies). This (or these) sleeve(s) is (are) set into place so that at least one sleeve is interposed between each pair of adjacent assemblies.

The sleeve may consist in a heat-retractable material. In this case, the method comprises a step for heating the assembly and the sleeve once the sleeve is set into place so that the sleeve clasps the assembly under the effect of heat.

Alternatively, the sleeve may be an elastic deformable annular ring, the dimensions of which are provided so that the sleeve is mounted clasped on the assembly in order to ensure its maintaining in position during assembling of the module. In this case, the sleeve is preferably mounted around the lower end of the body of the latter, which is in contact with the lid of the adjacent assembly (the assemblies being positioned head-to-tail), having the largest dimensions radially. When the assembly has the aforementioned architecture, a ring mounted around the body in its portion intended to be in contact with the lid of the adjacent assembly is therefore sufficient for insulating the whole of the adjacent assemblies. The ring may therefore be dimensioned so as to be of a width corresponding to that of the peripheral skirt of the lid.

Once the sleeve(s) are set into place, the different alternatives of the manufacturing method comprise the steps of:
positioning the assemblies on a support,
applying a force F on the assemblies,
positioning connection straps on the assemblies, and
connecting the straps on the assemblies.

These other steps differ in both embodiments illustrated in FIG. 1.

2.1. First Embodiment of the Method

The specific steps of the first embodiment of the module manufacturing method will now be described in more detail.

2.1.1. Placement of the Electrical Energy Storage Assemblies

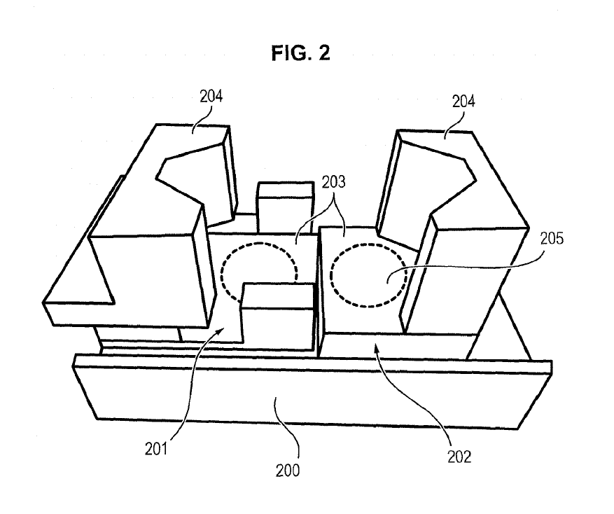

The first embodiment of the method comprises a step 120 consisting of placing all the assemblies of the module on a support 301, 302 which will be described in more detail subsequently with reference to the module manufacturing tools illustrated in FIGS. 2 to 4.

More specifically, each assembly is laid on the support at one of its ends (bottom or lid), so that the longitudinal axes of the assemblies extend substantially parallel with each other.

Advantageously, the assemblies are placed “head-to-tail”, i.e. the sleeves of adjacent assemblies are located on opposite ends of the assemblies as this is seen in FIG. 1.

2.1.2. Application of a Force

In another step 130, the method comprises the application of at least one force F (preferably a plurality of forces) on the assemblies in order to flatten (to press) the assemblies against each other. This force is applied along a direction perpendicular to the longitudinal axes of the assemblies and in a direction tending to bring them closer to each other.

2.1.3. Positioning of the Straps

The straps are then positioned (step 140) on the ends of the assemblies opposite to the ends in contact with the support.

Advantageously, the position of each strap is predetermined relatively to at least two reference planes P1, P2 each containing a direction parallel to the longitudinal axes of the assemblies, independently of the positions actually occupied by the assemblies—these actual positions may vary from one module to the other depending on the assembly plays related to the variations in dimensions of the assemblies, etc.

Thus, the positions of the straps remain constant during the making of two identical modules, and this regardless of the actual positions of the assemblies making up said modules.

The position constancy of the straps induces constancy in the position of each of the output terminals of the module intended to be connected to external electric apparatuses. Indeed, the output terminals of the module are connected to the straps.

Therefore a module is obtained for which the positions of the output terminals are standardized which facilitates its use at an industrial scale.

The reference planes are defined relatively to the support.

In every case, the position of each of the straps is defined prior to the manufacturing of the module, by taking into account possible variations in dimensions of the assemblies depending on the assembly plays and on the variations in dimensions of the parts making it up. In particular, the position of each strap is determined by considering the extreme sizes which the assemblies may have. Then, as a position for each strap the one is selected which allows connection of any combination of assemblies for which the dimensions are comprised between the extreme sizes.

The reference planes may be perpendicular to each other. One of the reference planes may be defined as being the plane passing through the output terminals of the module in order to limit the risks of inconsistency in the position of the output terminals. The other reference plane may be a plane of symmetry of the assemblies, perpendicular to the first reference plane. This allows optimization of the dimensioning of the straps. Indeed, the dispersion in the positions of the assemblies is reduced when one of the reference planes is a plane of symmetry of the assemblies. It is thus possible to maximize the contact surface area between the straps and the assemblies.

2.1.4. Connection of the Straps

The straps are then connected to the assemblies. The step for connecting the straps onto the assemblies may comprise welding. This welding may be carried out with any welding method known to one skilled in the art such as laser welding, friction-kneading welding, etc.

The connecting step may also comprise the displacement of one (or each) assembly along a vertical direction so that each assembly is bearing against a predetermined horizontal plane, notably delimited by a wall of the support or of the mask of the straps and against the strap. This gives the possibility of managing the dispersion of the dimensions of the different assemblies along the vertical direction. This also allows simultaneous welding of all the straps to the assemblies if this is desired. This displacement of one (or each) assembly along a vertical direction may be obtained by applying a force F′ along a vertical direction tending to lift the assemblies.

2.1.5. Turning over the Electrical Energy Storage Assemblies

In order to electrically connect the assemblies with each other, it is necessary to connect their two opposite ends to electrically conducting straps.

It is therefore necessary to turn (step 150) the assemblies connected to the straps over so as to connect the ends in contact with the support to other electrically conducting straps.

2.1.6. Connection of Straps on the Other Ends of the Electrical Energy Storage Assemblies

Once the assemblies have been turned over so that the straps bound to the assemblies in the preceding step are in contact with the support, a new step for positioning the straps is applied, similar to the step described in item 2.1.3.

A force F may be applied on the latter so as to flatten them together against the pair wise welded assemblies at one of their ends so that even the assemblies not yet welded are in intimate contact.

Also, a force F′ may be applied under the assemblies in order to displace them along a vertical direction so that each assembly is bearing against a predetermined horizontal plane.

Finally, the straps are welded to the assemblies.

The assemblies bound to the straps are then positioned in a casing in order to form the module.

2.2. Second Embodiment of the Method

The second embodiment of the module manufacturing method will now be described in more detail.

This second embodiment mainly differs from the first embodiment described above in that it comprises a step for making elementary pairs of assemblies, each elementary pair including two assemblies bound to a strap at one of their ends in order to place the pairs of assemblies in the support.

By making elementary pairs of assemblies, and by placing each of these elementary pairs on the support so that their straps are in contact with the support, one gets rid of the step 150 for turning over the assemblies, applied in the first embodiment. Also all the assemblies are assembled at the last moment, which gives the possibility of being able to minimize the consequences of possible anomalies of the method which would result in non-compliant connections. Indeed, it is less frequently necessary to discard the totality of the module.

This gives the possibility of simplifying the handling of the assemblies and limits the risks of degradation of the connections between the straps and the assemblies during the manufacturing of the module.

Indeed, the turning-over step may prove to be very difficult to apply when the manufactured module comprises a large number of assemblies, each assembly having a non-negligible weight.

2.2.1. Making Elementary Pairs

In a step 20 of the method, two assemblies are placed “head-to-tail” on a support 201, 202 so that their longitudinal axes extend vertically.

The assemblies are then pushed sideways against each other by applying a force F (step 30).

Once the assemblies are in contact, a strap is positioned on their ends opposite to the support (step 40). One of the assemblies (or both) may be displaced vertically so as to be flattened against the strap and so as to place the strap against an upper reference plane essentially horizontal and secured to the support. The strap is then welded onto the assemblies.

An elementary pair consisting of two assemblies and of a strap is thereby obtained.

The operation for producing elementary pairs is repeated the number of times as desired depending on the number of assemblies which are desired for the module.

2.22. Placement of the Elementary Pairs

The elementary pairs are then positioned (step 50) on the support 301, 302 so that the strap of each elementary pair is in contact with the support 301, 302.

There again, the elementary pairs are placed so that the sleeves of adjacent assemblies are located on opposite longitudinal ends of the assemblies. More specifically, at least two forces of different directions in the plane normal to the directions of the longitudinal axes of the assemblies are applied, so as to ensure maximum compactness in this plane. The forces are notably perpendicular with each other and only comprise a component located in this plane.

2.2.3. Applying a Force

A force F is then applied (step 60) to the elementary pairs for flattening the assemblies against each other. This force is applied along a direction perpendicular to the longitudinal axes of the assemblies and in a direction tending to bring them closer to each other.

2.2.4. Positioning of the Straps

In another step 70 of the method, the straps are positioned on the ends of the assemblies, the position of each strap being predetermined relatively to at least two reference planes parallel to the longitudinal axes of the assemblies. The straps are notably placed on a mask cooperating with fixed positioning means of the support.

The straps are then bound to the assemblies as described above (possible displacement of the assemblies vertically, and welding of the straps onto the assemblies).

The assemblies bound to the straps are then positioned in a casing in order to form the module.

3. Manufacturing Tool

Two examples of tools for manufacturing a module will now be described.

3.1. First Embodiment of the Tool

With reference to FIG. 2, an exemplary tool is illustrated allowing application of the operation for producing elementary pairs of assemblies.

The reader will have understood that this tool may also be used for manufacturing a module only comprising two assemblies.

The tool comprises a base 200 on which is positioned a support 201, 202 consisting of two translationally movable bases relatively to each other.

Each base is intended to receive a respective assembly.

Each base of the support 201, 202 comprises:
a tray 203 intended to be in contact with one of the longitudinal ends of the assembly, and
a support 204 extending perpendicularly to the tray and the shape of which is adapted to that of the cover of the assembly. The support 204 is conformed here so as to surround the cylindrical cover of the assembly essentially over the whole height of its sidewall and over one half of its circumference, and is in contact with the cover, preferably in several locations of the latter.

The tray also comprises a translationally movable pusher 205 along the vertical direction, parallel to the longitudinal axes of the assembly and therefore giving the possibility of modifying the vertical position of each of the assemblies, notably for putting the upper faces of the assemblies at the same level.

The tool may also comprise an upper wall, horizontal and notably jointed on the support via essentially horizontal hinges. This wall may then form an upper horizontal reference plane. This wall is optional and has not been illustrated in FIG. 2. Such a wall may be open worked in order to give the possibility of ensuring the weld of the strap on the assemblies through the latter.

The operating principle of the tool illustrated in FIG. 2 is the following. A respective assembly is placed on each base. The bases are then translationally displaced towards each other. The trays and supports of both bases are brought closer to each other, the assemblies positioned on the bases also are brought closer to each other. When the assemblies are in contact with each other, the supports of each base give the possibility of ensuring proper flattening of the assemblies against each other. A strap is positioned on the assemblies, and then is bound to the latter. Optionally, the trays are translationally displaced vertically by means of the pushers 205 for displacing the assemblies and the strap is set into place on the latter towards an upper reference plane so as to ensure proper contact between the assemblies and the strap and an improved weld of the strap and of the assemblies. Each of the assemblies may of course be displaced by a distinct height which is specific to it.

3.2. Second Embodiment of the Tool

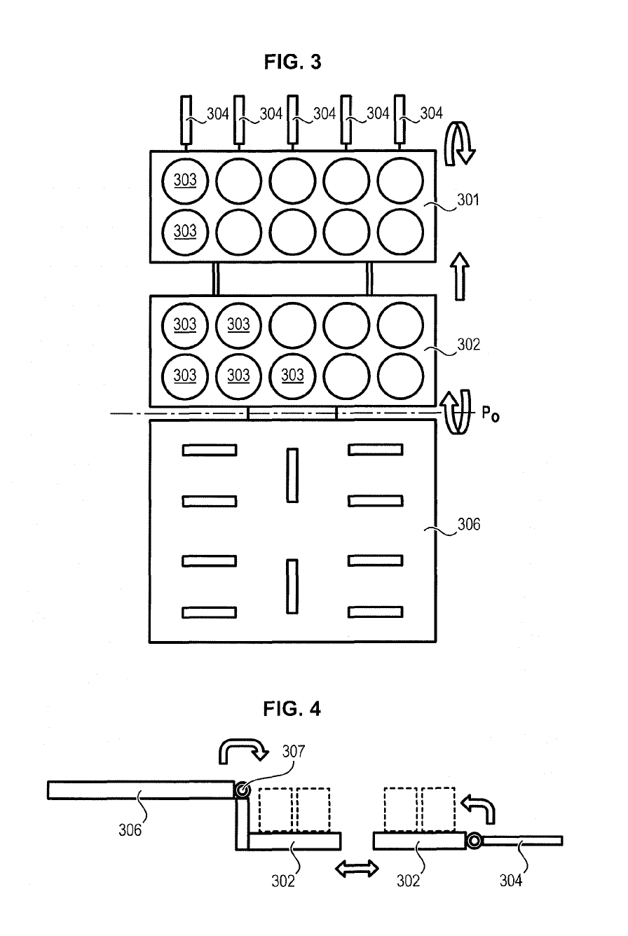

With reference to FIGS. 3 and 4 and 5A to 5D, another tool is illustrated for manufacturing a module. This tool may be used alone or as a combination with the tool described in the first embodiment of the invention, the pairs then formed by the tool according to the first embodiment of the invention being placed in the tool according to the second embodiment and which will be described hereafter.

As this is seen in FIGS. 3 and 4 illustrating the tool schematically, the tool comprises a support consisting of two frames 301, 302 each including a plurality of trays 303. These frames 301, 302 are translationally movable with respect to each other between:
a distant position where both frames are distant from each other for allowing passage of wiring of the module between the latter, and
a closer position where the frames are in contact with each other.

Each tray 303 is intended to receive a respective assembly. Each tray 303 is translationally movable vertically in order to allow displacement of its associated assembly along a direction substantially parallel to its longitudinal axis.

The tool also comprises pushers 304 positioned on at least one of the frames. Each pusher 304 is movable in rotation between a rest position and a force position where the pusher 304 is in contact with one of the assemblies for applying a force F on the latter in order to push them against a reference plane, here the reference plane P0 illustrated in dotted lines in FIG. 3 and extending in a plane perpendicular to that of the figure, the force F being normal to said plane.

The tool also comprises a lid 306 jointed on the support by means of hinges 307 with an essentially horizontal axis, the lid being movable between a disengaged position in which it is not superposed with the frames 301, 302 and a position in which it is superposed to the frames of the support so that it forms an upper essentially horizontal reference plane. The hinges 307 are for this purpose positioned at a height above that of the storage assemblies when the latter are placed on the respective trays 303 of the support.

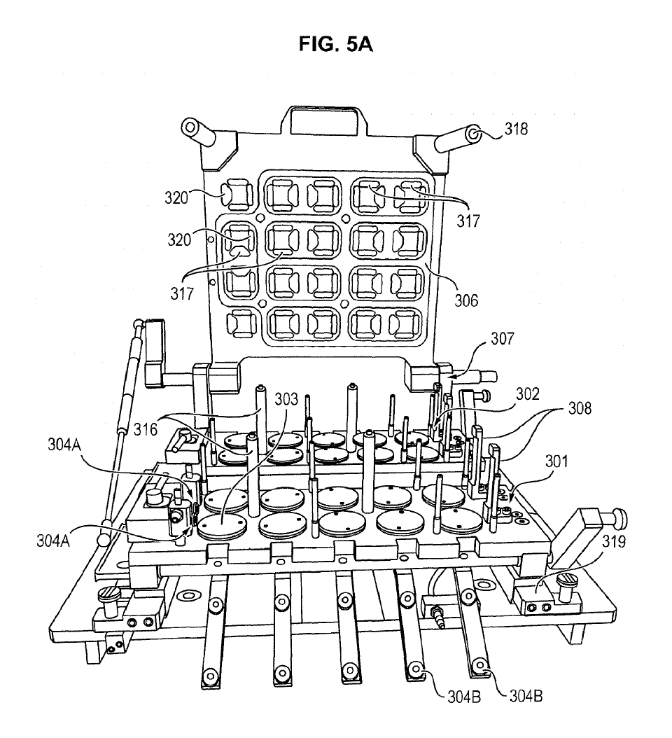

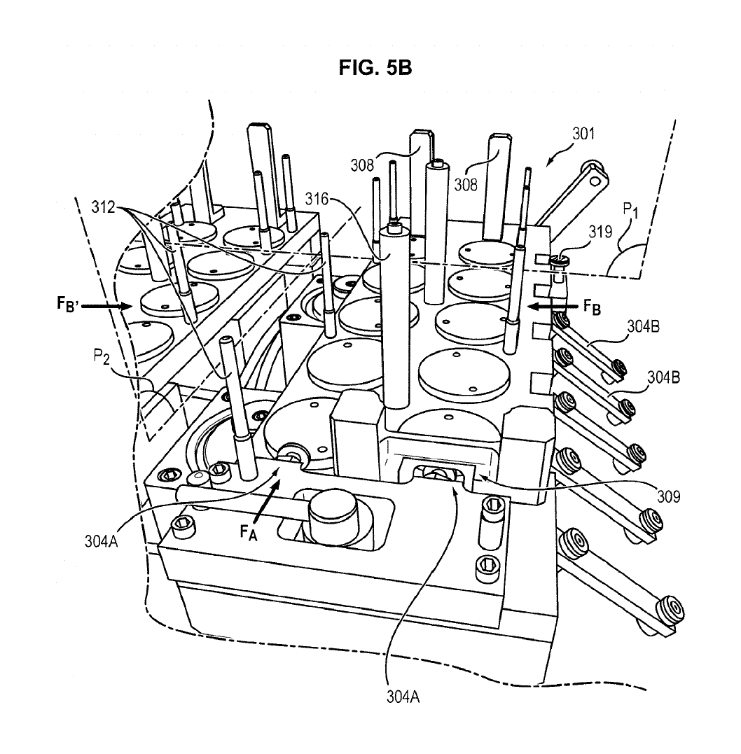

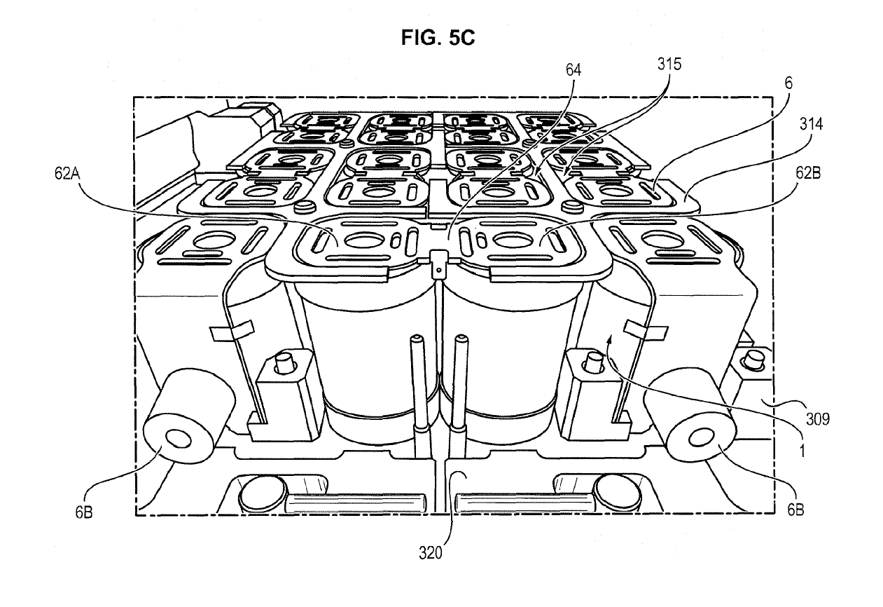

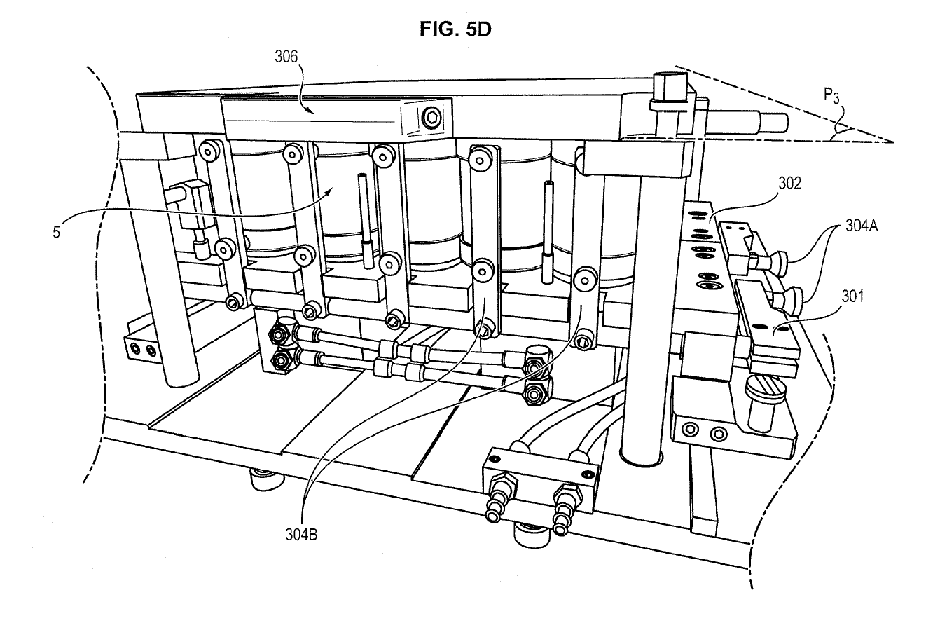

FIGS. 5A to 5D show an alternative of the second embodiment of the tool according to this embodiment, wherein the identical references are noted in the same way as in FIGS. 3 and 4. In these figures, the reference planes are a plane P1 extending at an end of the module and a perpendicular plane P2 located on the contact line of both frames 301, 302 in a closer position.

In order to materialize the plane P1, the tool comprises mechanical abutment means 308, corresponding to horizontal abutment walls located in the plane P1 against which the assemblies will come into contact. In order to push the assemblies against the mechanical means 308, the tool comprises essentially horizontal pushers 304A and located at the end of the tool opposite to the plane P1. These pushers 304A extend essentially perpendicularly to the plane P1 for pushing the assemblies against the abutment faces 308, according to a force F_{A} essentially horizontal. The tool also comprises, located on each side of the plane P2, pushing arms 304B connected to each of the frames 301, 302 (in the Figure, only the arms connected to the frame 301 are visible). These arms extend at each transverse end of the tool symmetrically relatively to the plane P2. They are movable in rotation relatively to a horizontal axis located at each transverse end of the module and will come into contact with the assemblies in the vicinity of the position in which they are vertical, as shown in FIG. 5D, so that they apply a respective pushing force F_{B}, F_{B}′ on said assemblies. The pushing forces F_{B}, F_{B}′ respectively applied on the assemblies placed on the frames 301, 302 are symmetrical relatively to the plane P2 and perpendicular relatively to this plane, i.e. of an opposite direction, essentially horizontal, and with an essentially identical intensity.

The pushing arms 304B may also apply on the assemblies a force with a vertical component but this component is compensated by the reaction of the support on the assembly and does not prevent displacement of the assembly. The forces applied on the assemblies at each end of the tool being identical, the assemblies join up together at the reference plane P2.

It will be noted that it is possible to only apply a pushing force on one side of the module and place the reference plane P2 on the opposite side of the support (like plane P0) but this configuration in which the plane P2 is a plane of symmetry of the module is advantageous, as explained earlier.

The tool also comprises, secured to the frames 301, 302, means 312 for positioning a mask 314, better visible in FIG. 5C including a plurality of clearances 315 intended to contain the connecting straps 6 intended for connecting the assemblies with each other. It will be noted that the mask 314 gives the possibility of obtaining a fixed position of the straps relatively to the reference planes P1, P2. The tool moreover comprises means 309 for maintaining the output terminals 6B of the module, connected to the straps and therefore also placed in the mask. The means 309 consist of an abutment face intended to come into contact with the terminal 6B, the position of which is perfectly determined considering the position of the abutment walls 308. As this has been indicated, the shape of the straps is selected according to manufacturing tolerances of the assemblies, so that the straps can only be superposed one single assembly at a time regardless of the characteristics of the assemblies placed in the module. It is well seen in FIG. 5C that the strap includes two rigid portions 62A, 62B respectively connected to both assemblies and a deformable portion 64 located in the middle of the two rigid portions and with a smaller thickness than the rigid portions.

The tool also comprises means for maintaining the position of the lid 306 forming an upper reference plane P3 visible in FIG. 5D, notably formed by vertical arms 316, 318, respectively secured to the lid and to the support and intended to cooperate with additional means (orifices 317 of the lid and pins 319 of the support), in order to maintain constant in any point the distance between the lid 306 and the frames 301, 302, in order to keep accurate positioning of the upper reference plane P3. It will also be noted that the lid 306 comprises open worked portions 320 for allowing the straps to be attained when the lid 306 is closed.

The operating principle of the tool is the following.

The maintaining member, the frames and the pushers are respectively displaced in the disengaged, separate and rest positions.

The assemblies are placed on the trays of the support. The straps are positioned in the locations of the maintaining member.

Once the wiring of the module is accomplished, the frames are displaced into their closer position. The pushers are actuated and move—in rotation for the pushers 304B and in translation for the pushers 304A—towards the assemblies until the assemblies of both frames 301, 302 are in contact at the plane P2 and the assemblies are in contact against the abutment faces 308 corresponding to the plane P1. The pushers therefore apply on the assemblies forces F_{A}, F_{B} and F_{B}′ tending to flatten them against each other. Once the assemblies are flattened together, the mask 314 is set into place wherein straps have been placed as shown in FIG. 5C, on the positioning means 312 of the tool. The output terminal 6B will then abut against the corresponding supporting means 309.

The lid 306 is displaced in rotation so as to be placed above the assemblies, at the prescribed height in order to form the horizontal reference plane P3. The trays 303 of the support are then displaced vertically in order to flatten the assemblies and the straps 6 against the lid 306. If the assemblies belonging to a same pair are not at the same height, it is possible that the straps already welded under the assemblies slightly bend at their portion 64 so that the strap 6 located on the assemblies are well flattened against the lid 306. Finally, the straps 6 are welded on the assemblies by means of the open worked portions 320 which are made in the lid. Because of the flattening of the straps against the upper reference plane P3, the surface of the strap and the associated one of the assembly are well parallel which guarantees good quality welding.

4. Conclusions

By means of the methods and tools described above, it is therefore possible to manufacture a module from assemblies for which the dispersion of the dimensions is significant.

With the manufacturing methods of the prior art, an assembly for which the dimensions were too different from those of the other assemblies making up the module could not be used.

The reader will have understood that many modifications may be made to the methods, tools and modules shown above without materially departing from the novel teachings described here.

Therefore, all the modifications of this type are intended to be incorporated within the scope of the appended claims.

1. A method for manufacturing an electrical energy storage module including electrical energy storage assemblies, each assembly including an external cover and an electrical energy storage element positioned inside the cover, wherein the method comprises the following steps:
the setting into place of at least one electrically insulating sleeve around the cover of at least one assembly so that a sleeve is interposed between each pair of adjacent assemblies, the at least one sleeve at least partly covering the cover of the at least one assembly,
the placement of one of the ends of each assembly on a support, so that the longitudinal axes of the assemblies extend substantially parallel with each other,
the application of at least one force on the assemblies along a direction perpendicular to the longitudinal axes of the assemblies, in order to flatten them against each other,
the positioning of at least one electrically conducting strap on the assemblies so as to electrically connect said assemblies, the position of the at least one strap being predetermined relatively to at least one reference plane of the support containing a direction parallel to that of the longitudinal axes of the assemblies, and
the connection, notably by welding, of the at least one strap on the assemblies.

2. The method according to claim 1, wherein the position of said strap is predetermined and independent of the actual positions of said assemblies.

3. The method according to claim 1, wherein the reference plane do not contain any of the longitudinal axes of the assemblies, the step for applying a force tending to flatten the assemblies against each other and against the reference plane(s) of the module.

4. The method according to claim 1, wherein the assemblies are flattened against at least two reference planes, the reference planes being perpendicular to each other, at least one of the reference planes preferably being a plane of symmetry of the assemblies.

5. The method according to claim 1, wherein during the placement step, each sleeve is positioned so as to cover one of the ends of a respective cover, the placement step being applied so that the sleeves of the adjacent assemblies are located on opposite longitudinal ends of the assemblies positioned side by side.

6. The method according to claim 1, wherein at least two forces of distinct directions are applied in the plane normal to the longitudinal axes of the assemblies.

7. The method according to claim 1, wherein the step for positioning the at least one strap comprises:
laying out the at least one strap on a supporting mask at a predetermined position relatively to said reference plane(s), and
affixing the supporting mask on means for positioning the support.

8. The method according to claim 1, wherein the connection step comprises a substep of moving at least one assembly, notably each assembly, along a direction substantially parallel to the longitudinal axes of the assemblies, so that the assemblies are bearing against the at least one strap.

9. The method according to claim 8, wherein, during the substep of moving at least one assembly along a direction substantially parallel to the longitudinal axes of the assemblies, the assemblies and the straps are moved so that the straps are bearing against a reference plane of the support, named “perpendicular reference plane”, essentially perpendicular to the longitudinal axes of the assemblies placed on the support.

10. The method according to claim 1, which further comprises a step for producing elementary pairs of assemblies prior to the placement step, said production step comprising the substeps:
a) positioning two assemblies so that their longitudinal axes extend substantially parallel to each other,
b) pushing both assemblies against each other,
c) installing and welding a connecting strap on both assemblies,
d) repeating steps a) to c) in order to obtain a plurality of elementary pairs, the step for placing the assemblies including placing the end welded to the connecting strap of each elementary pair on the support so that the connecting strap of each elementary pair is in contact with the support.

11. he method according to claim 10, wherein the connection step comprises a substep of moving at least one assembly, notably each assembly, along a direction substantially parallel to the longitudinal axes of the assemblies, so that the assemblies are bearing against the at least one strap, wherein, during the step for moving the assemblies along the longitudinal axes, the strap connected to the pair of assemblies is deformed so that the strap located at the opposite longitudinal end is supported with the perpendicular reference plane, the strap preferably including, for doing this, two rigid portions connected to the assemblies and a deformable portion extending between both rigid portions.

12. The method according to claim 11, wherein, during the step for producing elementary pairs, the substep of installing and welding comprises the displacement of at least one assembly, notably each assembly, along a direction substantially parallel to the longitudinal axes of the assemblies, so that the assemblies are bearing against the connecting strap, and optionally that the strap is in contact with a reference plane perpendicular to the longitudinal axes.

13. A manufacturing tool for applying a method for manufacturing an electrical energy storage module according to claim 1, this module including electrical energy storage assemblies, each assembly including an external cover and an electrical energy storage element positioned inside the cover, at least one electrically insulating sleeve being set into place around the external cover of at least one of the assemblies so that a sleeve is interposed between each pair of adjacent assemblies, wherein this tool comprises:
at least one support for placing one of the ends of each assembly, so that the longitudinal axes of the assemblies extend substantially parallel to each other,
at least one force applicator for applying at least one force on the assemblies along a direction substantially perpendicular to the longitudinal axes of the assemblies, the at least one force tending to flatten the assemblies against each other.

14. The tool according to claim 13, also comprising means secured to the support, for positioning at least one electrically conducting strap on the assemblies so as to electrically connect said assemblies, the position of the at least one strap being predetermined relatively to at least one reference plane of the support containing a direction parallel to the longitudinal axes of the assemblies.

15. The tool according to claim 13, wherein the support comprises at least two trays, each tray being intended for receiving a respective assembly, at least one tray, notably each tray, being translationally movable so as to move at least one assembly, notably each assembly, along a direction substantially parallel to the longitudinal axes of the assemblies, so that the assemblies are bearing against the at least one electrically conducting strap, and optionally that the strap is in contact with a reference plane perpendicular to the longitudinal axes.

16. The tool according to claim 15, wherein at least one tray, notably each tray, is translationally movable along a direction perpendicular to the longitudinal axes of the assemblies in order to flatten at least one assembly, notably each assembly, against the other assemblies.

17. The tool according to claim 13, wherein the support consists of two frames intended to each receive at least one assembly, said frames being translationally movable relatively to each other between:
a separate position where both frames are distant from each other in order to allow the passing of wiring of the module between the latter, and
a closer position where the frames are in contact with each other.

18. An electrical energy storage module including electrical energy storage assemblies, each assembly comprising an external cover and an electric energy storage element positioned inside the cover, wherein the module further comprises:
at least one electrically insulating sleeve around the cover of at least one of the assemblies so that a sleeve is interposed between each pair of adjacent assemblies, the at least one sleeve at least partly covering the external cover of the assembly, the assemblies being flattened against each other so that each sleeve is in contact with at least one of the adjacent assemblies,
at least one electrically conducting strap on the assemblies so as to electrically connect said assemblies, the position of the at least one strap being predetermined relatively to at least one reference plane containing at least one direction parallel to the longitudinal axes of the assemblies, said strap being a part which extends longitudinally, and which comprises a deformable portion between two rigid portions, each of the rigid portions being respectively connected to an assembly.

19. The module according to claim 18, wherein the position of the at least one strap is independent of the actual position of the assemblies of the module.

20. The module according to claim 18, which further comprises a casing in which are inserted the assemblies, the casing including at least one wall and a bottom, the at least one reference plane being defined relatively to the or at least one of the walls of the casing.
